(19) United States
(12) Patent Application Publication
(10) Pub. No.: US 2015/0151205 A1
(43) Pub. Date: Jun. 4, 2015

(54) MULTIPLE CHARACTER PVP GAME

(71) Applicant: DeNA Co., Ltd., Tokyo (JP)

(72) Inventor: Christopher Eugene Plummer, Lafayette, CA (US)

(21) Appl. No.: 14/557,336

(22) Filed: Dec. 1, 2014

Related U.S. Application Data
(60) Provisional application No. 61/910,884, filed on Dec. 2, 2013.
(60) Provisional application No. 61/911,971, filed on Dec. 4, 2013.

(51) Int. Cl. A63F 13/795

(52) U.S. Cl. CPC A63F 13/795

(57) ABSTRACT

Example implementations described herein are directed to a system for matching a plurality of players for a game in a virtual space. The system is configured to select at least one opposing player configured to play with respect to a first player based on a progress information of the at least one opposing player, and select the virtual space for the game based on location information of the selected at least one opposing player.

### CROSS REFERENCE TO RELATED APPLICATIONS

The present application claims priority from U.S. provisional application No. 61/910,884, filed Dec. 2, 2013 and U.S. provisional application No. 61/911,971, filed on Dec. 4, 2013, the disclosure of which is incorporated by reference in its entirety for all purposes.

### BACKGROUND

1. Field

The present disclosure relates generally to multiplayer games, and more specifically, to multiplayer player versus player games.

2. Related Art

Runner style games have historically only used distance as competitive element, not survival.

Driving games only have the user compete against one (1) car when competing against one (1) specific player.

### SUMMARY

In example implementations of the present inventive concept, the user can compete against multiple vehicles from the same player (in a non-limiting example, more than 10). Example implementations of the present inventive concept provide a user with a way to own multiple characters configured to attack other players on the user's behalf when attacked asynchronously.

In example implementations of the present inventive concept, multiple defending-player-owned characters are encounter throughout the environment by the attacking player. One advantage of the implementations of the present invention is that they may provide a much more varied experience, which is desirable for user engagement.

Example implementations of the present inventive concept may solve the problem where asynchronous PvP (e.g., player v. player) has never been interesting in a runner game. The example implementations add a combat/survival element to PvP where a player is trying to survive against another player, and may provide an advantage to players owning more characters, which is good for monetization and for variety.

Aspects of the present disclosure may include a system for matching a plurality of players for a game in a virtual space. The system may include one or more processors configured to execute computer-readable instructions in a non-transitory computer-readable medium. The instructions may involve selecting at least one opposing player configured to play with respect to a first player based on a progress information of the at least one opposing player, and selecting the virtual space for the game based on location information of the selected at least one opposing player.

Aspects of the present disclosure may further include a system for providing a game to be executed by at least one player. The system may involve a server that include a storage, storing an opponent information managing table which manages a opponent information including a progress information of the at least one player; a character information managing table which manages a character information indicating at least one character associated with the at least one player; and a location information managing table which manages a location information indicating a virtual space at which the at least one player last played. The system may also include one or more processors configured to execute computer program modules, the computer program modules including a server module configured to check the progress information to the opponent information managing table, upon receiving a request to execute a game from the first player; select at least one opposing player to be played with the first player, based on the progress information of the first player and the at least one opposing player; determine an opposing player, upon receiving a selection from the first player; check the character information of the opposing player to the character information managing table; check the location information of the opposing player to the location information managing table; and generate a game information to be presented to the first player. The system may further include a client device, connected with the server via a network, that includes one or more processors configured to execute computer program modules, the computer program modules including a client module configured to determine a control input from a first player and a game view according to the game information from the server and the control input from the first player; and a display unit which provides at least visual information including the game view, to the first player, wherein the server module is configured such that the at least one character of the at least one opposing player is respectively selected and located at the virtual space, based on the character information and the location information.

Aspects of the present disclosure may further include a server for providing a game to be executed by at least one player. The server may include a storage, storing an opponent information managing table which manages a opponent information including a progress information of the at least one player; a character information managing table which manages a character information indicating at least one character associated with the at least one player; and a location information managing table which manages a location information indicating a virtual space at which the at least one player last played. The server may also include at least one processor configured to execute computer program modules, the computer program modules including a module configured to check the progress information to the opponent information managing table, upon receiving a request to execute a game from the first player; select at least one opposing player to be played with the first player, based on the progress information of the first player and the at least one opposing player; determine an opposing player, upon receiving a selection from the first player; check the character information of the opposing player to the character information managing table; and check the location information of the opposing player to the location information managing table. The module is configured such that the at least one character of the opposing player is respectively selected and located at the virtual space, based on at least the character information and the location information.

### BRIEF DESCRIPTION OF DRAWINGS

FIG. 1 is a schematic illustration of a system configured to facilitate a game play of a user, according to an example implementation.

FIG. 2 is a table managing the opponent information table, according to an example implementation.

FIG. 3 is a table representing the managing of the player's character information, according to an example implementation.

FIG. 4 is a table representing the managing of the character's location information, according to an example implementation.

FIG. 5 is a flowchart of matching players at PvP mode processed in the server according to an example implementation.

FIG. 6 is a flowchart of the basic game process in the wireless client device communicating with the server, according to an example implementation.

FIG. 7 illustrates an example user interface for a player when a player logs into a game or completes a game, in accordance with an example implementation.

FIG. 8 illustrates a user interface for presenting a preview of the opponent, in accordance with an example implementation.

FIG. 9 illustrates a character selection screen for a player prior to starting a game, in accordance with an example implementation.

FIGS. 10-11 illustrate operation of a game after the execution of example implementations.

### DESCRIPTION OF EXAMPLE IMPLEMENTATIONS OF THE PRESENT APPLICATION

The phrase in an “example implementation” as used herein does not necessarily refer to the same implementation, though it may. As described below, implementations of the inventive concept may be readily combined, without departing from the scope or spirit of the inventive concept. In addition, throughout the specification, the meaning of “a,” “an,” and “the” include plural references. The meaning of “in” includes “in” and “on.” The term “coupled” implies that the elements may be directly connected together or may be coupled through one or more intervening elements.

The example implementations center on the use of another player's inventory of characters, weapons, or vehicles to populate a game environment that would otherwise be populated by enemies defined by a designer. The player is pursued by the opposing player's characters, which are controlled by AI (e.g., artificial intelligence). These AI-controlled characters are substantially identical to the characters owned by the opposing player and have comparable tuning parameter settings and special abilities (e.g., that match the other player's characters' attributes). Although the example implementation is described by using automobiles in motion, this is non-limiting and other scenarios including but not limited to runner games, driving games, combat games, role playing games, card battle games and derivatives, are contemplated without departing from the scope of the present inventive concept.

One element that makes this process and design unique is that instead of trying to escape from enemies chosen by a designer, the player is escaping from enemies arranged from the character inventory of another player with whom they are competing. Furthermore, the environment (e.g. virtual space) in which gameplay takes place is determined by the opposing player's location in the game. Accordingly, if a player who was last seen on a specific map is being challenged, then the PvP gameplay experience against that player will be set within that substantially similar environment against their actual characters. This may deliver a compelling sense of player-versus-player (PvP) action that may differ, depending on the player with which the competing occurs, where the player was last seen, and what the player owns, in terms of characters or cars, for example.

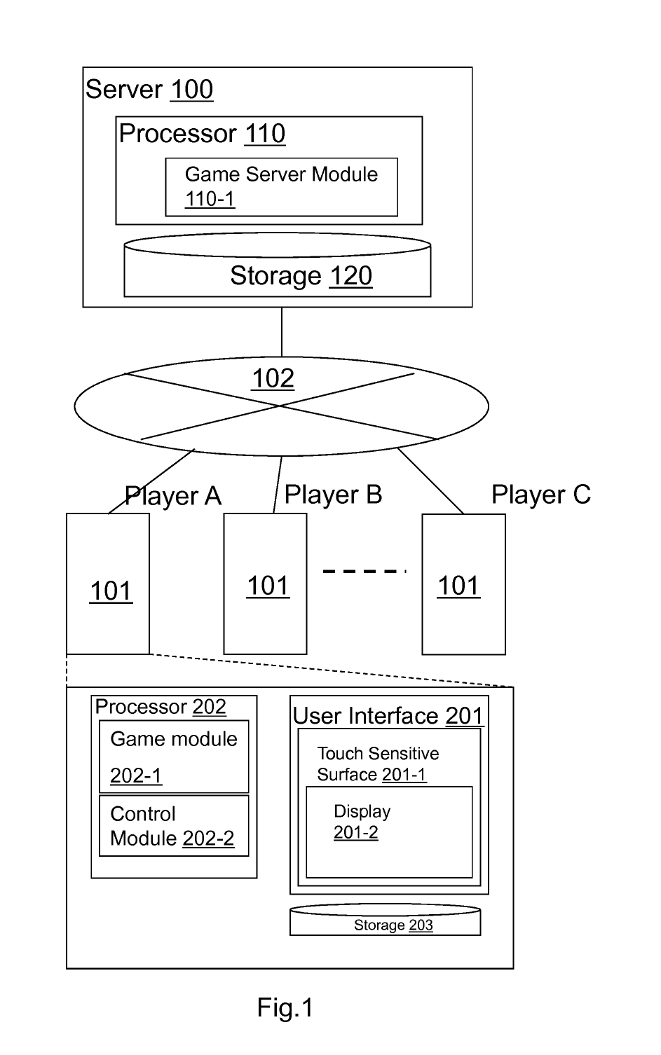

FIG. 1 is a schematic illustration of a system configured to facilitate a game play of a user, according to an example implementation. A system may comprise a server 100 and a plurality of wireless client devices 101 (for example, but not by way of limitation, a smartphone) communicatively connected with the server 100 via a network 102. The wireless client device 101 may comprise a user interface 201, one or more processors 202, and storage 203. The user interface 201 may be configured to interact with the user who may provide control inputs via a touch sensitive surface 201-1 (e.g., touch screen), buttons, or any other means including an external device coupled to the client device. The processor 202 may include a game module 202-1, and a control module 202-2. The game module 202-1 may be configured to determine a game view according to control inputs from the user and the information from the server 100. The control module 202-2 may be configured to determine control inputs from the user. The display 201-2 may be configured to present visual information including one or more views of the game, to the user.

The server 100 may comprise one or more processors 110 and storage 120. The processor 110 may comprise a game server module 110-1, which may be configured to communicate with a plurality of the wireless client devices to exchange the game data including the data related to the user. In this example implementation, the data may include each player's character information, status information and mapping information, which may be stored in the storage.

In the below description, example implementations are provided with respect to an implementation of a car game. However, the present disclosure is not limited to such an implementation and can be adjusted depending on the desired implementation. For example, if a role playing game is desired, the cars may be substituted for role playing game characters, with the other information as described in the figures similarly adjusted.

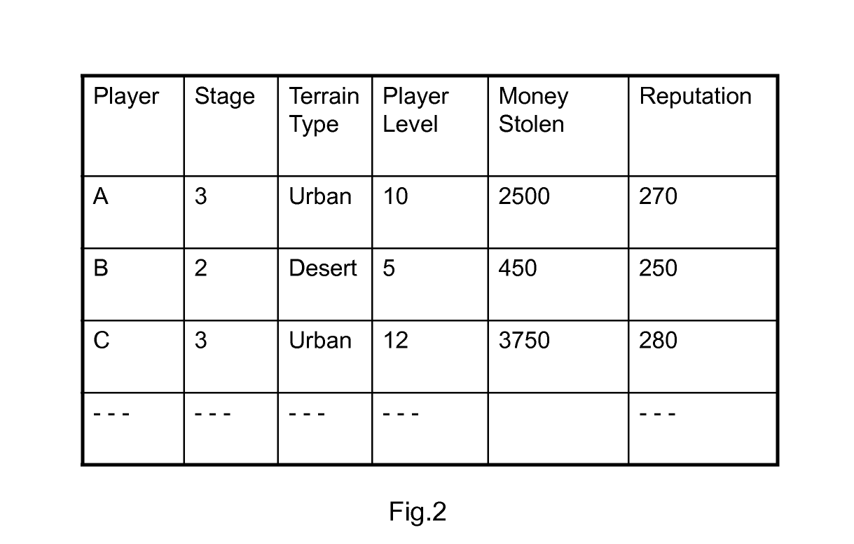

FIG. 2 is a table managing the opponent information table, according to an example implementation. The opponent information table may include a list of players that are eligible for being opponents for a particular player. In an example implementation involving a car combat game, the opponent information table may include the player identifier (A, B, C), the stage last played by the player, the terrain type of the stage (urban, desert, etc.) the level of the player, money or other valuable consideration that can potentially be taken from the player in a PvP match should a player achieve victory, and/or a reputation rating which can serve as a skill rating and be adjusted up or down depending on a victory or defeat. Other example implementations are also possible depending on the game implementation, and are not limited to the information utilized in FIG. 2, but can be adjusted to have suitable information parameters for a desired game implementation. For example, but not by way of limitation, if a role playing type game is implemented, terrain type may be replaced by magic type or player class.

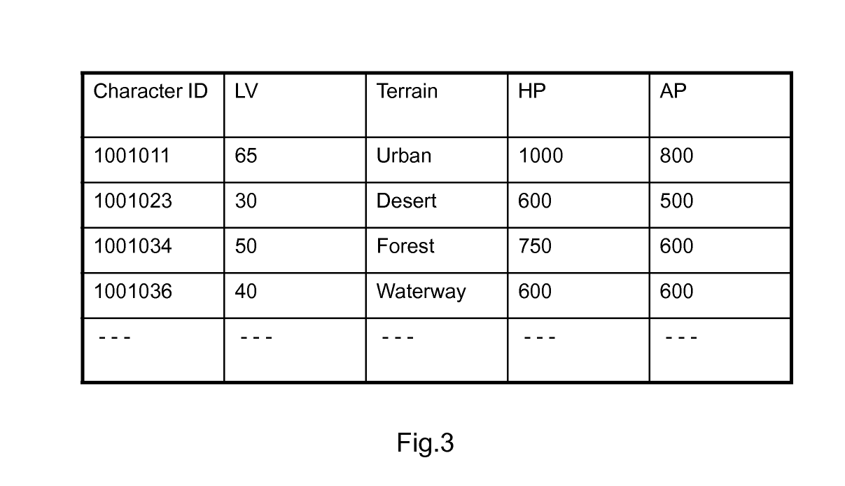

FIG. 3 is a table representing the managing of the player's character information, according to an example implementation. In an example implementation, this can be in the form of an inventory list of characters for a player or for an opponent. The character information may include (but is not limited to) the character ID, the character's level, terrain type, HP (Hit Point) and AP (Attack Point/Power). In one example implementation, Player B owns a plurality of the characters (e.g., cars) as listed in the table in FIG. 3. When Player A competes with Player B at PvP mode, the game server module may refer to the player's character information and may locate the cars owned by Player B in the course layout. Special bonuses (e.g. increased AP or HP) may be rewarded to cars having a terrain type that match the stage. As with FIG. 2, other implementations are also possible depending on the game implementation, and is not limited to the information utilized in FIG. 2.

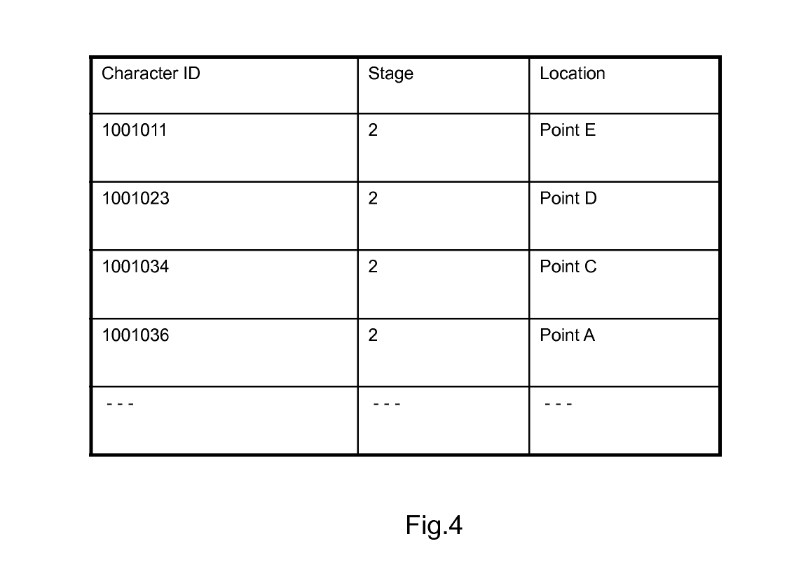

FIG. 4 is a table representing the managing of the character's location information, according to an example implementation. The character's location information may include (but is not limited to) the information as to which point on the course the player played with each character (car). For example, if the car identified as “1001011” past Point A through Point E, but did not finish the goal, the flag is set as “True” for Point A to Point E but “False” for Goal. When the game server module locate Player B's cars in the course layout, it would be possible to locate the cars based on the information as to the point at which each car last appeared in the course. In another example implementation, the cars can be populated on the stage based on the stage layout and preset spawning points which are selected for each car at random, thereby eliminating the use of the information in FIG. 4. Some or all of the character inventory may be utilized when the layout is generated. In an example implementation, a player challenging an opponent may face all of the cars in the opponent's inventory while being restricted to selecting and playing with only a few cars from the player's inventory, depending on the desired implementation.

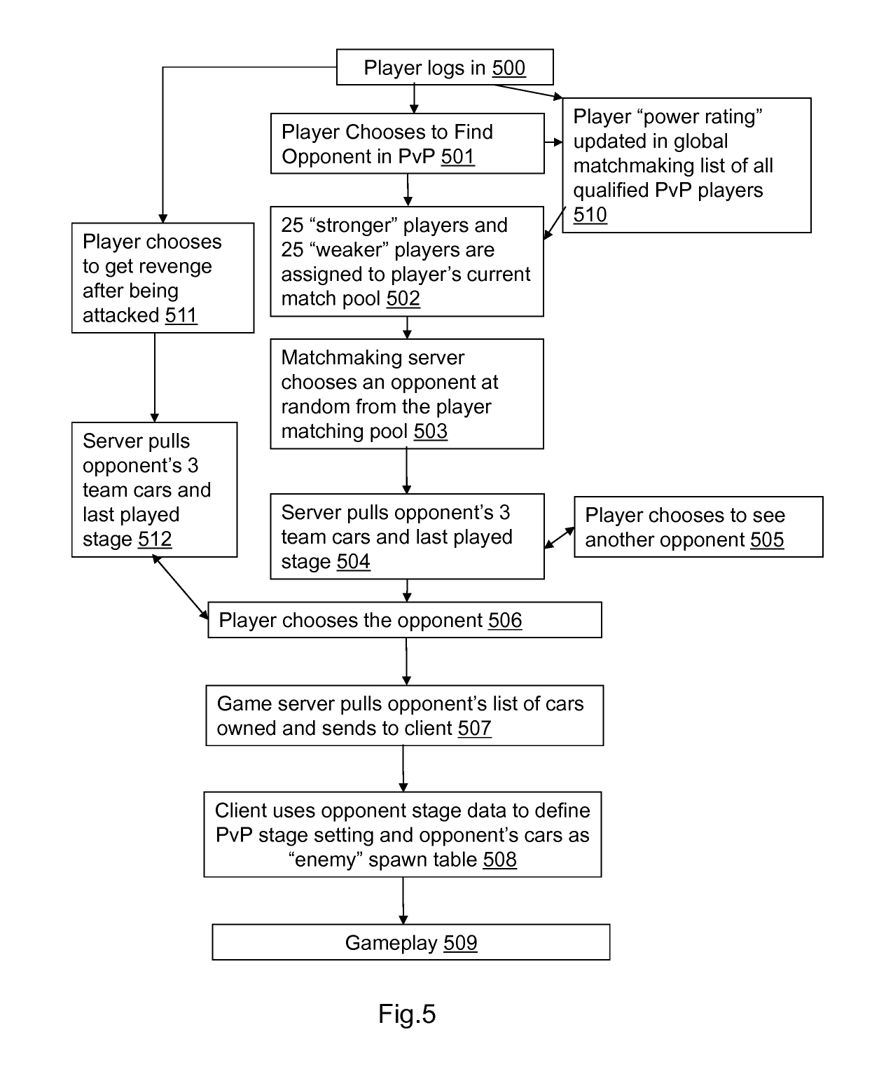

In PvP mode, a player competes with the opposing player by attacking and defending from each other's cars. For example, Player A first selects an opposing Player B among a plurality of players to select, and selects Player A's car(s) from the Player A's inventory. The selection and list of eligible players for selection is described in further detail with respect to FIG. 5. After PvP game has been started, Player A controls driving a car by touching on the touch sensitive screen and pausing the game by not touching the screen (e.g., the entire game environment including both Player A and non-player character (NPC) including Player B's cars is paused). Alternatively, the game can also continue when the screen is not touched, depending on the desired implementation. Player A controls to drive a car along the street course while collecting coins or other items placed in the street. In one example implementation, the cars of Player B may be spawned at random spawn points of the street course, which can be implemented by the use of splines along the stage course or other techniques. In another example implementation, Player A encounters the Player B's car at the point where Player B's car was seen in the street course when Player B last played the game. If Player B owned a plurality of cars, then Player A may encounter those cars as they were seen in the Player B's last game.

When Player A's car and Player B's car approach within the distance (e.g., the predetermined distance), Player B's car is controlled by AI to chase and attack the Player A's car. Player A may control driving Player A's car such that it moves away from the Player B's car to avoid Player B's car's attack.

Conversely, when one's cars are attacked by the other player, it is the one player's collection of cars that the other player will have to face and have to survive against. For example, if Player A has another car located in the street course, and the Player A's located car and the Player B's car come close within the distance (e.g., predetermined distance), then the Player A's located car is controlled to prevent the Player B's car's attack.

Therefore, the player's own collection of cars serves as a defense against attacking players. The more “desirable” cars the player has, the stronger his/her defense.

In one implementation a player may have the opportunity to self locate cars at the desired location in the course layout. For example, if the player wanted to save the “best” characters until last, the player would place them later in the environment.

Also, instead of locating the multiple cars at the substantially same time, it is possible that when Player A has collection of cars, Player A may control one car by another each time one car is wrecked by another player's attack. For example, when one car is destroyed, the next car may be used to respawn at the location where the previous car was destroyed. In another example, when one car is destroyed the game may switch control of another car of Player A from AI control to direct control by Player A.

FIG. 5 is a flowchart of matching players at PvP mode processed in the server according to an example implementation. In this example implementation, asynchronous play between players is assumed (e.g., opponent can be challenged despite being offline), however synchronous play can also be implemented depending on the desired implementation (e.g., online opponent may choose to control one of the characters). When a player logs in 500, a player may choose to enter into a PvP game by selecting an option to find an opponent in PvP at 501. The game server module 110-1 may then generate a list of potential opponents as illustrated in FIG. 2 to serve as the player's match pool at 502. In an example implementation 25 stronger and weaker players are assigned to the player's match pool, however other numbers of stronger and weaker players may also be utilized depending on the desired implementation. The game server module 110-1 (or a matchmaking server, depending on the desired implementation) may then randomly select an opponent from the player matching pool at 503. In an alternate implementation the Player himself may select an opponent.

The game server module 110-1 may then retrieve opponent character information as illustrated in FIG. 3 and provide a preview to the challenging player by presenting three cars and the last played stage of the potential opponent to the player at 504. The player may then request a different opponent as shown at 505 or choose the opponent presented by the game server as shown at 506. The server may present multiple opponents at once or may present a singular opponent depending on the implementation.

When the player chooses the opponent to challenge, the game server module then retrieves the full character inventory of the opponent from the information of FIG. 3 to send to the client to populate the layout as shown at 507. The client of the Player then utilizes the last played stage of the opponent to define the PvP setting and use some or all of the inventory of the opponent to populate the stage and/or serve as a spawn table as shown at 508. The player can then start the game and challenge the opponent as shown at 509. In an alternate implementation, a random stage may be selected.

In the asynchronous implementation, the opponent can be offline and the character inventory of the opponent can be controlled by AI. Such an asynchronous implementation can also allow other players to challenge the player even while the player has already instigated a game with an opponent. Separate instances of the game would thereby be spawned at the client's of the other players, with the inventory information of the player similarly transmitted to those clients to facilitate similar gameplay. Thus, it can be possible for the player's power rating (e.g., reputation) to be modified even if the player is offline, in the middle of playing a game, or determining an opponent for selection. Thus, the player power rating can be updated while generating a potential list of opponents as shown at 510.

As other players may attack the player while the player is playing a game with an opponent, or while the player is offline, the player may later choose to get revenge against such players in a subsequent game selection as shown at 511. In a similar manner, the game server module may provide an information preview of such players, wherein the player can select that player for a PvP game as shown at 512.

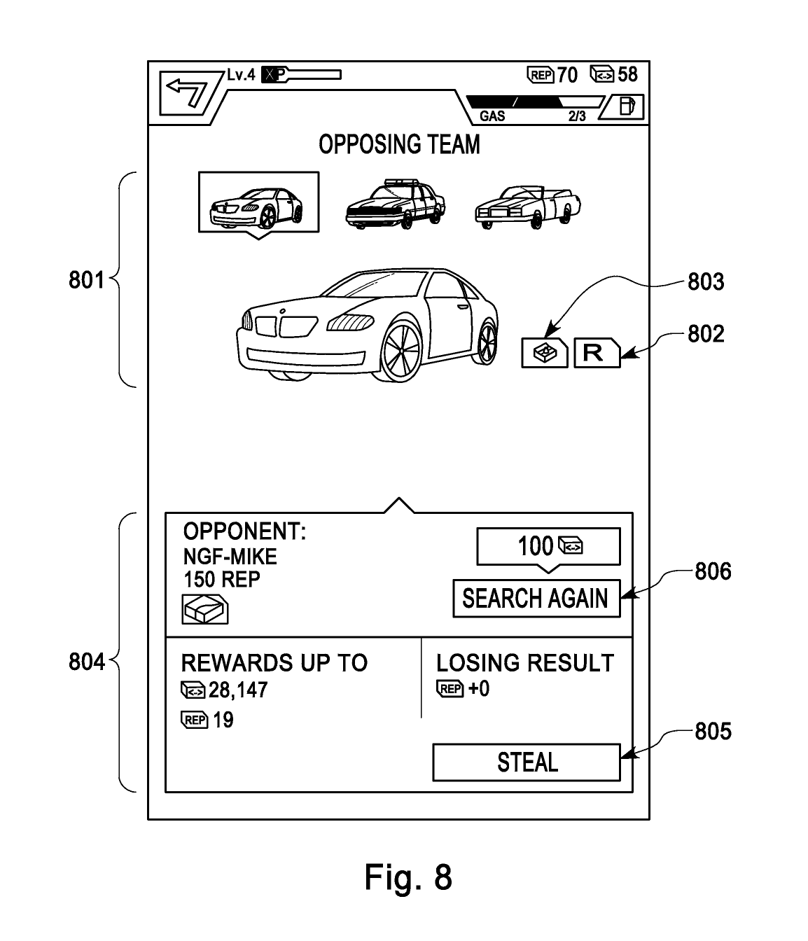

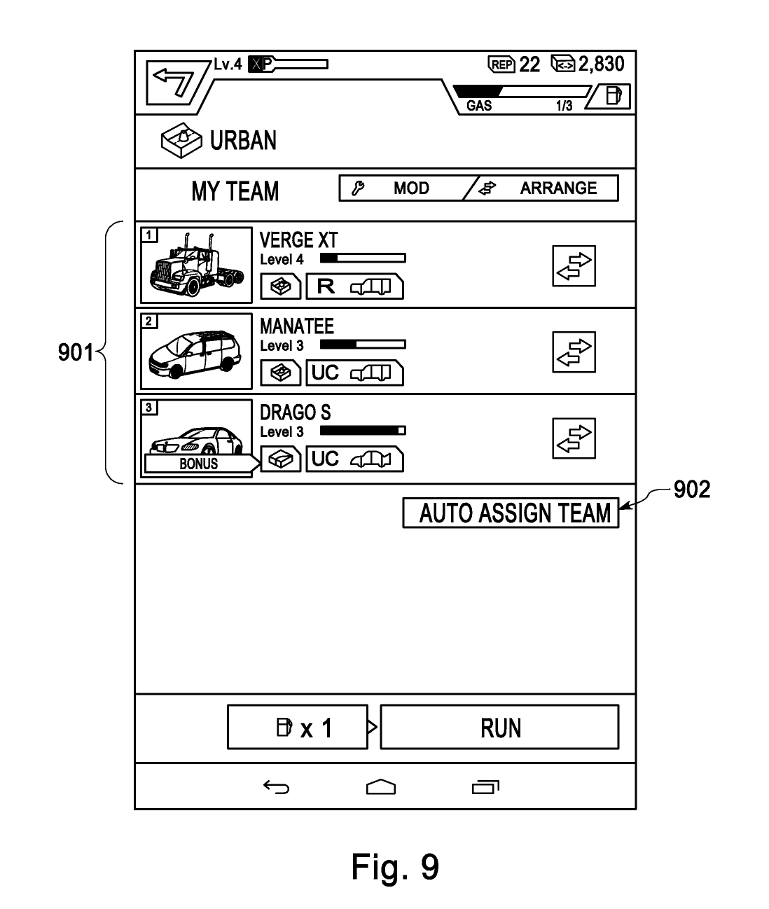

In the above example implementation, the game server module may check the opponent's inventory to the player's character information managing table when recommending opposing players, so that the player is able to check the opponent's inventory when selecting the opponent (See FIG. 8, for example). Further, the game server module may check the player's inventory to the player's character information managing table after selecting the opponent so that the player is able to check and review the player's inventory before starting the game (See FIG. 9, for example).

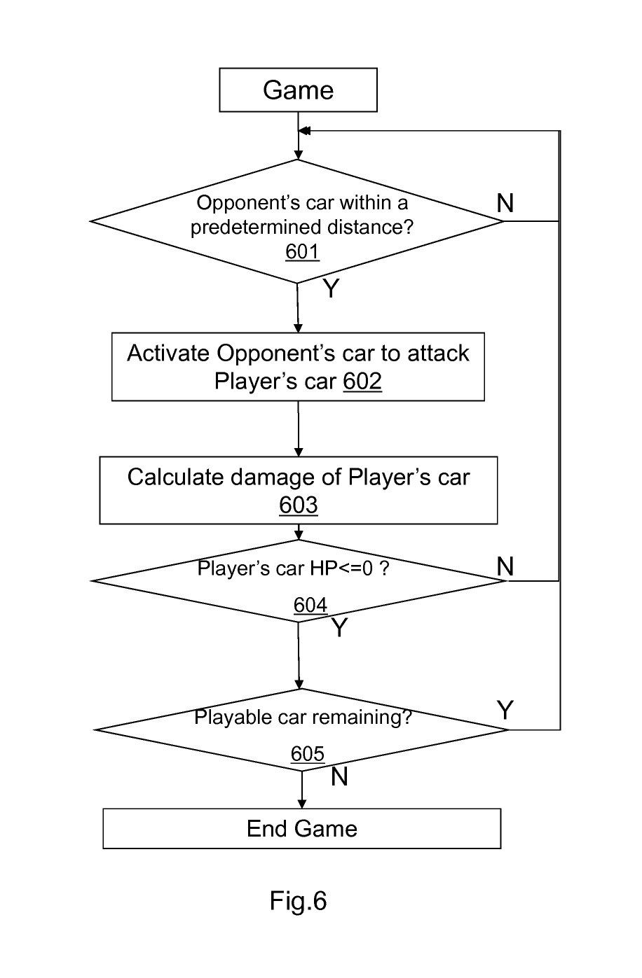

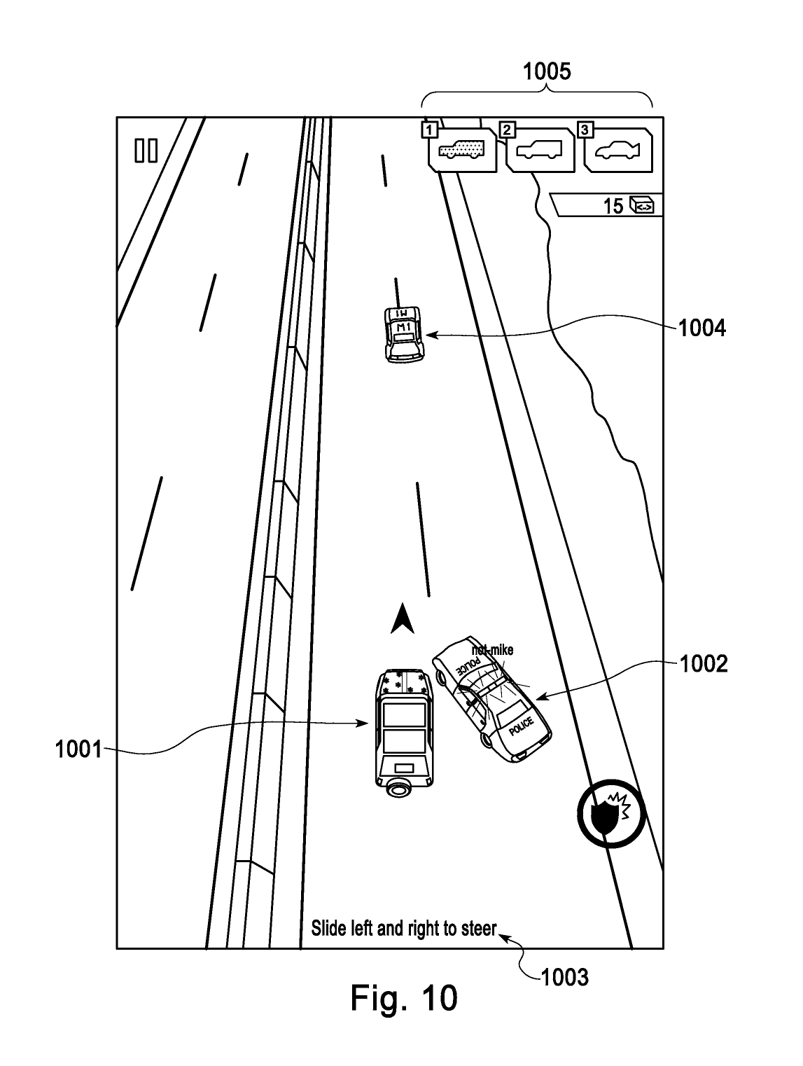

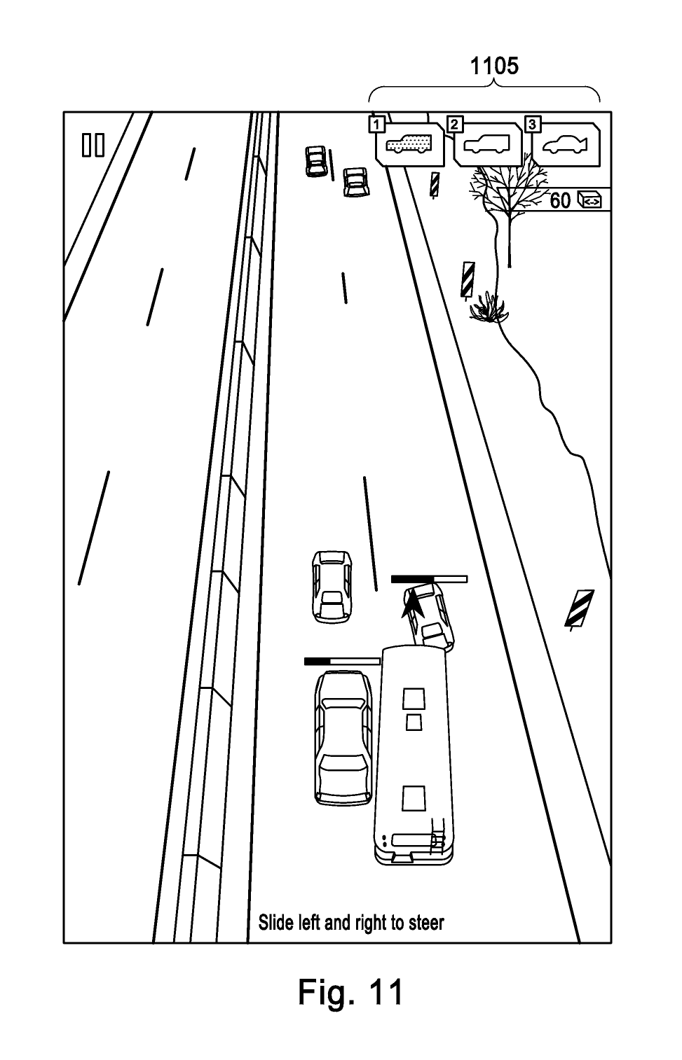

FIG. 6 is a flowchart of the basic game process in the wireless client device 101 communicating with the server 100, according to an example implementation. The control module 202-2 first determines if the player's car and opponent's car are within a distance (e.g., predetermined) as shown at 601. If the answer is “yes”, the opponent's car is activated to attack the player's car as shown at 602 (See also FIG. 10, for example). If the answer is “no”, the game is continued without the opponents appearing in the course. When the control module 202-2 detects the player's car hit by the opponent's car, the game module 202-1 calculates the damage to the player's car as shown at 603, and sends the information as to the damage amount, to the server 100, in order to request for the information as to whether the updated player's HP is zero or below as shown at 604. If the updated player's car's HP is more than zero, the game is continued. If the updated HP is zero or below, the game module then requests the server 100 whether the player's cars remain to play an extra game. If the player has more playable cars, the game is continued with the new car (See FIG. 11, for example). If the player has no more cars with which to play, the game is over.

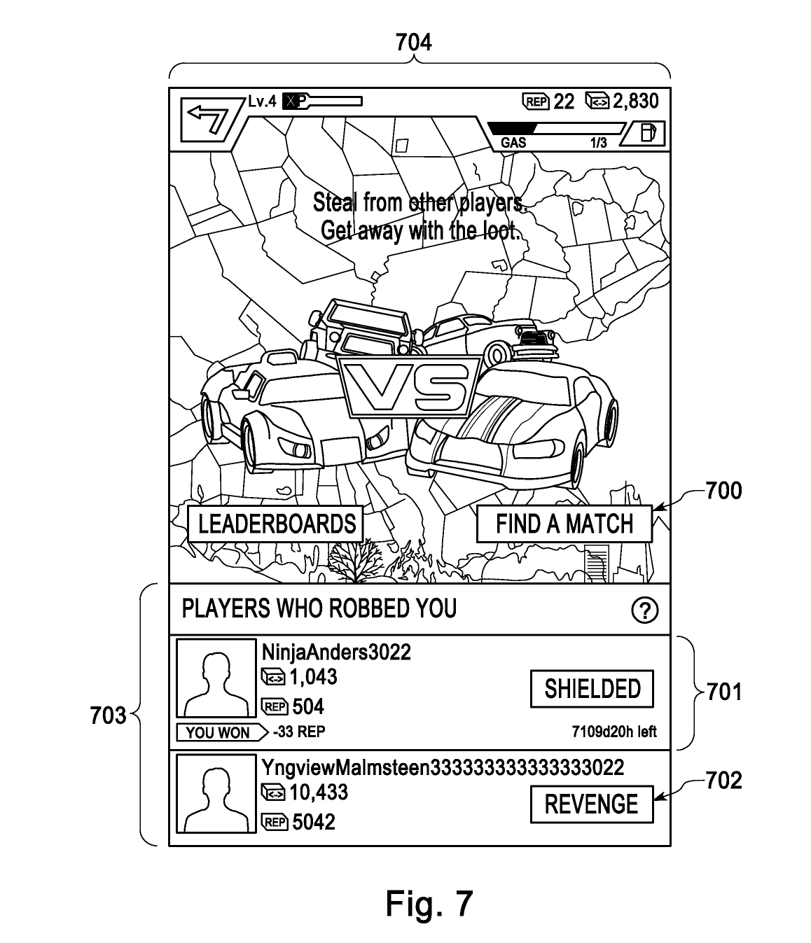

FIG. 7 illustrates an example user interface for a player when a player logs into a game or completes a game, in accordance with an example implementation. Under this option, the player may select a revenge, may attempt to find a match, or may attempt to use the leaderboard to view the leaders of the game. Selection of the Find a Match 700 option may cause the game server module 110-1 to generate a list of opponents and select one opponent at random for presentation to the player. Other status indicators can also be presented depending on the desired implementation. In this example implementation, the player achieved a victory against one opponent, who is thereby shielded from further challenges for a period of time (e.g., a predetermined period of time by the game server module such as a number of hours, days, etc.) as shown at 701. While the player played the prior game, another opponent attacked the player asynchronously, thereby permitting the revenge option against that opponent as shown at 702. As shown in FIG. 7, the opponents who previously competed with the player are shown, as well as indicia of total points, reputation points, and in the case of the shielded player, the number of reputation points lost or won in the previous competition as shown at 703. At the top of the screen, metrics or indicia of the player are shown, including but not limited to reputation points, total points, level, and remaining gas as shown at 704. As would be understood in the art, other indicia may be substituted for the illustrated indicia.

FIG. 8 illustrates a user interface for presenting a preview of the opponent, in accordance with an example implementation. In this example implementation, three objects (e.g., cars) from the inventory of the opponent are presented as a preview as shown at 801. The objects used for the preview can be implemented based on the desired implementation. For example, each player may preset a number of objects for display, or the game server module 110-1 can select a number of objects with the highest level for the preview. As shown in FIG. 8, each car may have a rarity indictor (e.g., rare, uncommon, common, etc.) as shown at 802, as well as a terrain type which indicate bonuses or penalties for playing a car in a stage with a certain terrain as shown at 803. Additional information such as reputation points of the opponent, money (e.g., points) and reputation gained upon a victory, and consequences of defeat can also be presented as shown at 804. The user may also be presented with an option to search for a different opponent 806, or to initiate the game 805.

FIG. 9 illustrates a character selection screen for a player prior to starting a game, in accordance with an example implementation. The player is given a choice to assemble a team to challenge some or all of the opponents cars during gameplay as shown at 901. The player may be restricted to selecting only a few cars from the player inventory, and is thereby presented with an option to a team auto assigned 902 or to arrange the team for the game. Additional information that can be presented can be taken from the character inventory information of the player as illustrated in FIG. 4. Such information can include the level of the car, the terrain type for determining bonuses or penalties for the car, the level of the car and the experience needed for the car to reach the next level.

While FIGS. 7-9 illustrate an example implementation prior to the start of a PvP game competition, FIGS. 10-11 illustrate operation of a game after the execution of the foregoing example implementations. Accordingly, the opponent need not be logged in or online during execution. Thus, the game can be played with only the player communicatively coupled to the server (e.g., platform or cloud), and thus, the instructions can be performed in any varying combination between the server and the client (e.g., smartphone, tablet or other client device), as would be understood in the art.

For example, in FIG. 10, the object operated by the player 1001 is attached by the opponent from the right. The opponent is indicated by the writing “ngf-mike” at the location of the opponent's object 1002, e.g., police car in this case. At the bottom of the screen, a hint is provided for the player as shown at 1003. Additional traffic 1004 is shown close to the top of the display, which may not be a car belonging to the opponent. At the top right, the number of remaining cars of the player are shown at 1005. In FIG. 11, the player has used the first car, and is now using the second of the cars as shown at 1105. The player is colliding with two other cars in combat or competition. The colliding cars may be include opponent cars as well as non-opponent cars, e.g., ordinary traffic. Additional traffic is shown at the top of the screen.

The processes and procedures described and illustrated herein may also be implemented by software, hardware, or any combination thereof other than those explicitly stated for the example implementations. More specifically, the processes and procedures described and illustrated herein may be implemented by the installation of the logic corresponding to the processes into a medium such as an integrated circuit, a volatile memory, a non-volatile memory, a magnetic disk, or an optical storage. The processes and procedures described and illustrated herein may also be installed in the form of a computer program, and executed by various computers.

Even if the processes and the procedures described herein are executed by a single apparatus, software piece, component, or module, such processes and procedures may also be executed by a plurality of apparatuses, software pieces, components, and/or modules. Even if the data, tables, or databases described herein are stored in a single memory, such data, tables, or databases may also be dispersed and stored in a plurality of memories included in a single apparatus or in a plurality of memories dispersed and arranged in a plurality of apparatuses. The elements of the software and the hardware described herein can be integrated into fewer constituent elements or can be decomposed into more constituent elements.

With respect to the use of substantially any plural and/or singular terms herein, those having skill in the art can translate from the plural to the singular and/or from the singular to the plural as is appropriate to the context.

1. A system for matching a plurality of players for a game in a virtual space, the system comprising one or more processors configured to execute computer-readable instructions in a non-transitory computer-readable medium, the instructions comprising:
selecting at least one opposing player configured to play with respect to a first player based on a progress information of the at least one opposing player, and
selecting the virtual space for the game based on location information of the selected at least one opposing player.

2. The system of claim 1, wherein the location information is associated with a virtual space at which the at least one opposing player last played.

3. The system of claim 1, wherein the progress information is associated with a skill rating.

4. The system of claim 3, wherein the selecting the at least one opposing player comprises selecting the at least one opposing player from a pool of players, the pool of players comprising at least one first opposing player with a skill rating higher than a skill rating of the first player, and at least one second opposing player with a skill rating lower than a skill rating of the first player.

5. The system of claim 1, wherein the selecting the at least one opposing player comprises, for a selection of a revenge option from the first player, selecting the at least one opposing player that last attacked the first player.

6. The system of claim 1, wherein the instructions further comprise updating the progress information of the at least one opposing player.

7. A system for providing a game to be executed by at least one player, the system comprising:
a server comprising:
a storage, storing:
an opponent information managing table which manages a opponent information including a progress information of the at least one player;
a character information managing table which manages a character information indicating at least one character associated with the at least one player; and
a location information managing table which manages a location information associated with a virtual space at which the at least one player last played; and
one or more processors configured to execute computer program modules, the computer program modules comprising a server module configured to:
check the progress information to the opponent information managing table, upon receiving a request to execute a game from the first player;
select at least one opposing player to be played with the first player, based on the progress information of the first player and the at least one opposing player;
determine an opposing player, upon receiving a selection from the first player;
check the character information of the opposing player to the character information managing table;
check the location information of the opposing player to the location information managing table; and
generate a game information to be presented to the first player; and
a client device, connected with the server via a network, comprising:
one or more processors configured to execute computer program modules, the computer program modules comprising a client module configured to determine a control input from a first player and a game view according to the game information from the server and the control input from the first player; and
a display unit which provides at least visual information including the game view, to the first player, wherein the server module is configured such that the at least one character of the at least one opposing player is respectively selected and located at the virtual space, based on the character information and the location information.

8. The system of claim 7, wherein the progress information is associated with a skill rating.

9. The system of claim 8, wherein the server module is configured to select the at least one opposing player by selecting the at least one opposing player from a pool of players, the pool of players comprising at least one first opposing player with a skill rating higher than a skill rating of the first player, and at least one second opposing player with a skill rating lower than a skill rating of the first player.

10. The system of claim 7, wherein the server module is configured to select the at least one opposing player by, for a selection of a revenge option from the first player, selecting the at least one opposing player that last attacked the first player.

11. The system of claim 7, wherein the server module is configured to update the progress information of the at least one opposing player.

12. A server for providing a game to be executed by at least one player, the server comprising:
a storage, storing:
an opponent information managing table which manages a opponent information including a progress information of the at least one player;
a character information managing table which manages a character information indicating at least one character associated with the at least one player; and
a location information managing table which manages a location information associated with a virtual space at which the at least one player last played; and
at least one processor configured to execute computer program modules, the computer program modules comprising a module configured to:
check the progress information to the opponent information managing table, upon receiving a request to execute a game from the first player;
select at least one opposing player to be played with the first player, based on the progress information of the first player and the at least one opposing player;
determine an opposing player, upon receiving a selection from the first player;
check the character information of the opposing player to the character information managing table; and
check the location information of the opposing player to the location information managing table,
wherein the module is configured such that the at least one character of the opposing player is respectively selected and located at the virtual space, based on at least the character information and the location information.

13. The server of claim 12, wherein the progress information is associated with a skill rating.

14. The server of claim 13, wherein the module is configured to select the at least one opposing player by selecting the at least one opposing player from a pool of players, the pool of players comprising at least one first opposing player with a skill rating higher than a skill rating of the first player, and at least one second opposing player with a skill rating lower than a skill rating of the first player.

15. The system of claim 2, wherein the module is configured to select the at least one opposing player by, for a selection of a revenge option from the first player, selecting an opposing player that last attacked the first player.

16. The system of claim 12, wherein the server module is configured to update the progress information of the at least one opposing player.
